(19) United States
(12) Patent Application Publication
(10) Pub. No.: US 2011/0305427 A1
(43) Pub. Date: Dec. 15, 2011

(54) Imaging Apparatus

(75) Inventor: Chen-Ping Yang, Taipei City (TW)

(73) Assignee: DIGILIFE TECHNOLOGIES CO., LTD., Taipei City (TW)

(21) Appl. No.: 12/797,189

(22) Filed: Jun. 9, 2010

(51) Int. Cl. H04N 5/00; H04N 5/77; H04N 5/775

(52) U.S. Cl. 386/230; 386/E05.003; 386/362

(57) ABSTRACT

An imaging apparatus includes an audio/video capture mechanism and an output mechanism movably installed at a side of the audio/video capture mechanism, and the output mechanism includes a first display unit and a second display unit installed on both surfaces of the output mechanism respectively and coupled to the audio/video capture mechanism, such that the imaging apparatus can display a captured image by the first and second display units and allow a photographer to view the content of a captured image while taking the picture of his own, as well as allowing the photographer and a photographed party to simultaneously view the content of a capture image, so as to achieve a more practical photographical effect to cope with different requirements.

### FIELD OF THE INVENTION

The present invention relates to an imaging apparatus, in particular to an imaging apparatus allowing a photographer to view the content of a captured image while taking the picture of his own, as well as allowing the photographer and a photographed party to simultaneously view the content of a capture image, so as to achieve a more practical photographical effect.

### BACKGROUND OF THE INVENTION

In general, a conventional imaging apparatus is comprised a camera and a display installed at a side of the camera, and the display can be turned out from the side of the camera to capture or play desired videos, and the display is provided for displaying the captured image and taking a picture, so as to achieve the photographic effect.

Since a general imaging apparatus comes with only one lens, a photographer has to turn the display over to view the content of the captured image while taking a picture of his own, but such arrangement is inconvenient. Furthermore, the single display cannot allow both photographer and photographed party to simultaneously view the content of the captured image and may result in a poor photo. Obviously, the conventional imaging apparatus cannot meet user requirements.

Therefore, it is a main subject for the invention to provide an imaging apparatus that gives a better practical photographic effect to meet different photographic requirements.

### SUMMARY OF THE INVENTION

In view of the shortcomings of the conventional imaging apparatus, the inventor of the present invention based on years of experience in the related industry to conduct extensive researches and experiments, and finally developed an imaging apparatus, in hope of achieving the effects of providing a better practical photographic effect to meet different photographic requirements.

Therefore, it is a primary objective of the present invention to provide an imaging apparatus that displays a captured image by first and second display units and allows a photographer to view the content of a captured image while taking the picture of his own, as well as allowing the photographer and a photographed party to simultaneously view the content of a capture image, so as to achieve a more practical photographical effect to cope with different requirements.

To achieve the foregoing objective, the present invention provides an imaging apparatus, comprising: an audio/video capture mechanism; and an output mechanism movably installed at a side of the audio/video capture mechanism, and a first display unit and a second display unit are installed on both surfaces of the output mechanism respectively and coupled to the audio/video capture mechanism.

In a preferred embodiment of the present invention, the audio/video capture mechanism includes a casing body, an audio/video processing unit installed in the casing body, an image capture unit installed at an end of the casing body and coupled to the audio/video processing unit, a sound input/output unit installed at an end of the casing body and coupled to the audio/video processing unit, an operating unit installed onto the casing body and coupled to the audio/video processing unit, an electric power unit installed in the casing body and coupled to the audio/video processing unit, and a storage unit installed at an end of the casing body and coupled to the audio/video processing unit.

In a preferred embodiment of the present invention, the output mechanism includes an external casing, an axle installed at a side of the external casing and combined with the audio/video capture mechanism, and a window portion formed separately on both surfaces of the external casing, and the first and second display units correspond to the window portions on both surfaces of the external casing respectively, and the first and second display units can be touch panels or liquid crystal displays.

Therefore, the imaging apparatus of the present invention can display a captured image by first and second display units and allow a photographer to view the content of a captured image while taking the picture of his own, as well as allowing the photographer and a photographed party to simultaneously view the content of a capture image, so as to achieve a more practical photographical effect to cope with different requirements.

### BRIEF DESCRIPTION OF THE DRAWINGS

FIG. 1 is an exploded view of a preferred embodiment of the present invention;

FIG. 2 is another exploded view of a preferred embodiment of the present invention;

FIG. 3 is a perspective view of a preferred embodiment of the present invention; and

FIGS. 4 and 5 are schematic views of an application in accordance with a preferred embodiment of the present invention respectively.

### DESCRIPTION OF THE PREFERRED EMBODIMENTS

The objects, characteristics and effects of the present invention will become apparent with the detailed description of the preferred embodiments and the illustration of related drawings as follows.

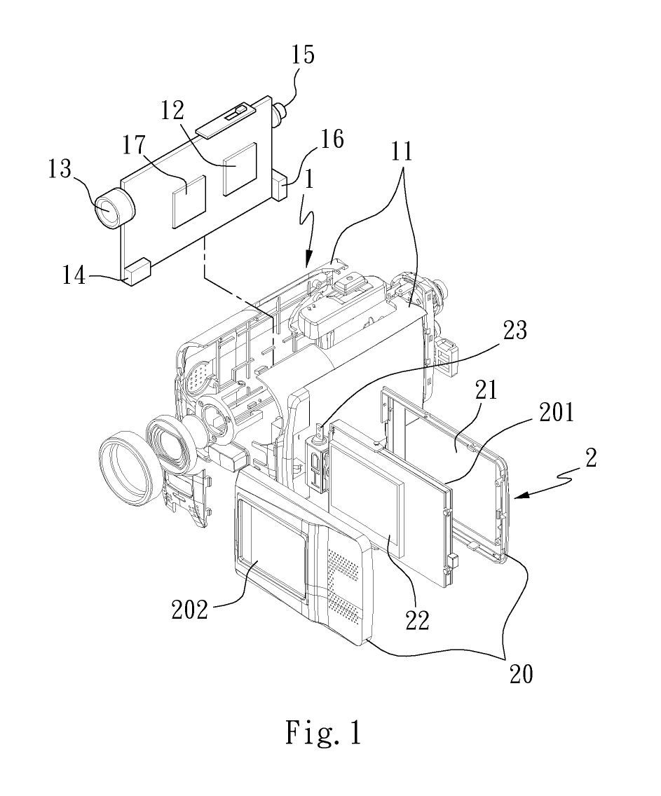

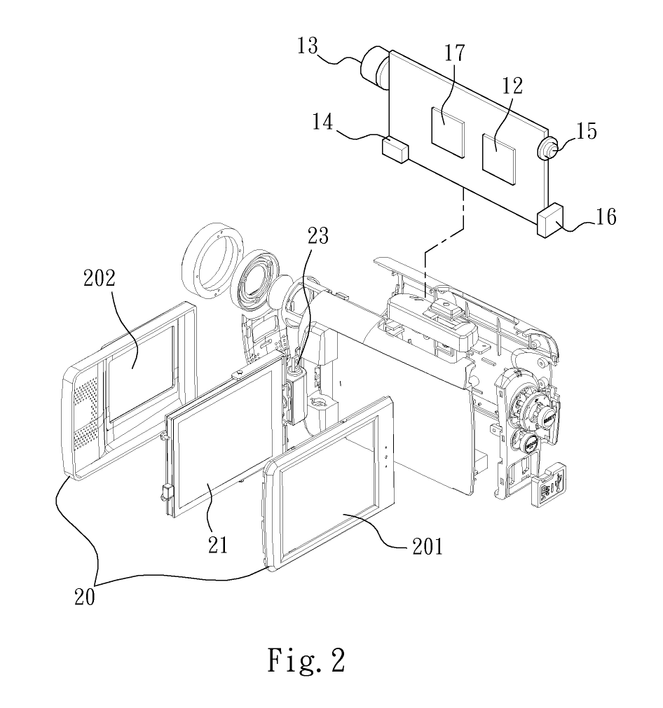

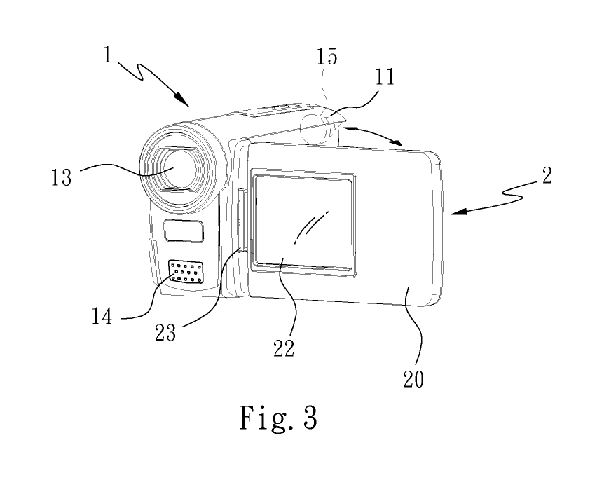

With reference to FIGS. 1 to 3 for exploded views and a perspective view of an imaging apparatus in accordance with a preferred embodiment of the present invention respectively, the imaging apparatus is comprised of an audio/video capture mechanism 1 and an output mechanism 2.

The audio/video capture mechanism 1 includes a casing body 11, an audio/video processing unit 12 installed in the casing body 11, an image capture unit 13 installed at an end of the casing body 11 and coupled to the audio/video processing unit 12, a sound input/output unit 14 installed at an end of the casing body 11 and coupled to the audio/video processing unit 12, an operating unit 15 installed onto the casing body 11 and coupled to the audio/video processing unit 12, an electric power unit 16 installed in the casing body 11 and coupled to the audio/video processing unit 12, and a storage unit 17 installed at an end of the casing body 11 and coupled to the audio/video processing unit 12.

The output mechanism 2 is movably installed at a side of the audio/video capture mechanism 1, and a first display unit 21 and a second display unit 22 are installed on both surfaces of the output mechanism 2 respectively and coupled to the audio/video capture mechanism 1, wherein the output mechanism 2 includes an external casing 20, an axle 23 installed at a side of the external casing 20 and combined with the casing body 11 of the audio/video capture mechanism 1, and a window portion 201, 202 formed separately on both surfaces of the external casing 20, and the first display unit 21 and second display unit 22 correspond to the window portions 201, 202 on both surfaces of the external casing 20 respectively, and the first display unit 21 and second display unit 22 can be touch panels or liquid crystal displays.

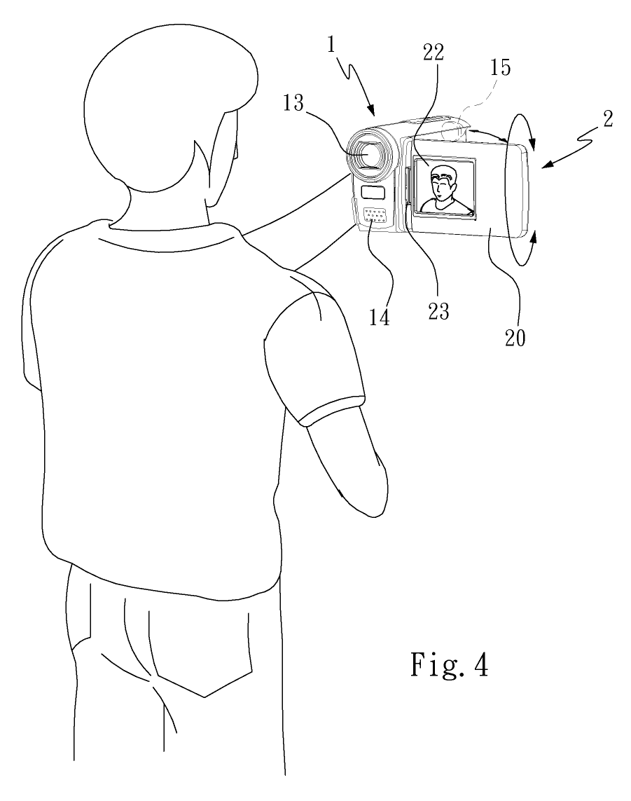

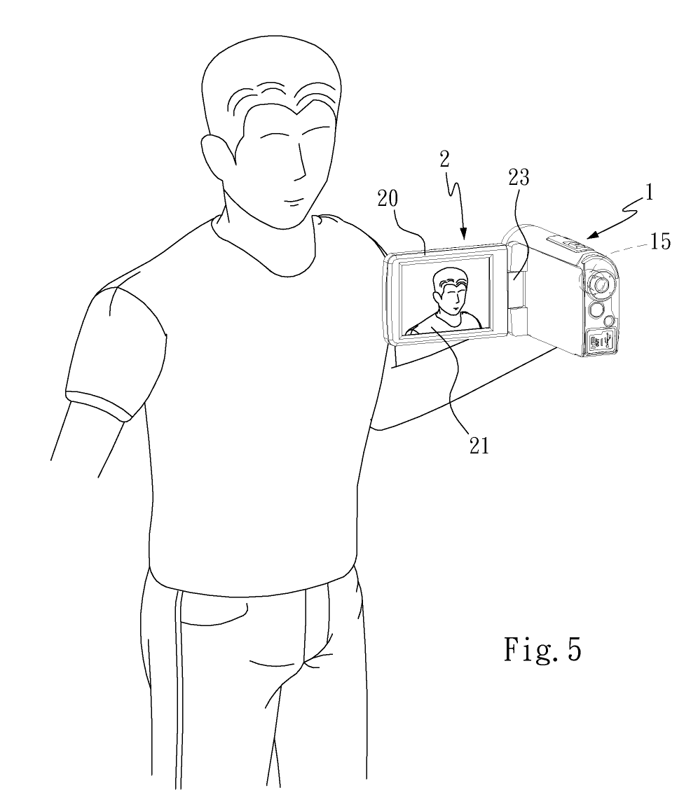

With reference to FIGS. 4 and 5 for schematic views of an application in accordance with a preferred embodiment of the present invention respectively, when the invention is applied (also refer to FIGS. 1 to 3 at the same time), the output mechanism 2 can be turned out from a side of the casing body 11 of the audio/video capture mechanism 1 by using the axle 23 at a side of the external casing 20 (and the output mechanism 2 can be turned over by the axle 23, which will not be described further here), and the electric power unit 16 is provided for supplying electric power for the operation, and the operating unit 15, image capture unit 13, sound input/output unit 14 and storage unit 17 are operated together with the audio/video processing unit 12 to capture and store (or read and play) desired videos, and the captured image is displayed from the first and second display units 21, 22 by the audio/video processing unit 12 of the audio/video capture mechanism 1, such that a photographer can view the content of a captured image from the second display unit 22 while taking the picture of his own, as well as allowing the photographer and photographed party to simultaneously view the content of a capture image from the first and second display units 21, 22, so as to achieve a more practical photographical effect to cope with different requirements.

In summation of the description above, the present invention displays the captured image from the first and second display units while taking a picture, so that a photographer can view the content of the captured image while taking the picture of his own, as well as allowing the photographer and photographed party to simultaneously view the content of a capture image, so as to achieve a more practical photographical effect to cope with different requirements, and the invention also complies with the patent application requirements, and products derived from the present invention can fully meet the present market requirements.

While the invention has been described by means of specific embodiments, numerous modifications and variations could be made thereto by those skilled in the art without departing from the scope and spirit of the invention set forth in the claims.

What is claimed is:

1. An imaging apparatus, comprising:
an audio/video capture mechanism; and
an output mechanism, movably installed at a side of the audio/video capture mechanism, and having a first display unit and a second display unit installed on both surfaces of the output mechanism respectively and coupled to the audio/video capture mechanism.

2. The imaging apparatus of claim 1, wherein the audio/video capture mechanism includes a casing body, an audio/video processing unit installed in the casing body, an image capture unit installed at an end of the casing body and coupled to the audio/video processing unit, a sound input/output unit installed at an end of the casing body and coupled to the audio/video processing unit, an operating unit installed onto the casing body and coupled to the audio/video processing unit, an electric power unit installed in the casing body and coupled to the audio/video processing unit, and a storage unit installed at an end of the casing body and coupled to the audio/video processing unit.

3. The imaging apparatus of claim 1, wherein the output mechanism includes an external casing, an axle installed at a side of the external casing and combined with the audio/video capture mechanism, and a window portion formed separately on both surfaces of the external casing, and the first and second display units correspond to the window portions on both surfaces of the external casing respectively, and the first and second display units are touch panels or liquid crystal displays.
